(19) United States
(12) Patent Application Publication
(10) Pub. No.: US 2024/0258542 A1
(43) Pub. Date: Aug. 1, 2024

(54) FUEL CELL SYSTEM AND METHOD FOR DETERMINING NO-LOAD OPERATION STATE THEREOF

(71) Applicant: HYUNDAI MOBIS CO., LTD., Seoul (KR)

(72) Inventor: Yong Hee LEE, Yongin-si (KR)

(73) Assignee: HYUNDAI MOBIS CO., LTD., Seoul (KR)

(21) Appl. No.: 18/538,209

(22) Filed: Dec. 13, 2023

(30) Foreign Application Priority Data
Jan. 26, 2023 (KR) 10-2023-0010136

(51) Int. Cl. H01M 8/04537; H01M 8/04014; H01M 8/04082; H01M 8/04089; H01M 8/04492; H01M 8/04746

(52) U.S. Cl. CPC H01M 8/04619; H01M 8/04014; H01M 8/04097; H01M 8/04201; H01M 8/04492; H01M 8/04753

(57) ABSTRACT

A fuel cell system and method are provided. The fuel cell system includes a fuel cell stack, a fuel water trap to store condensate generated by the fuel cell stack, and a controller. After a change in a water level of the fuel water trap, the controller determines whether the fuel cell stack is in a non-load operation state based on a first parameter indicating a ratio between a power consumption of an accessory machine and the change in the water level.

### CROSS-REFERENCE TO RELATED APPLICATION

This application claims the benefit of priority to Korean Patent Application No. 10-2023-0010136, filed in the Korean Intellectual Property Office on Jan. 26, 2023, the entire contents of which are incorporated herein by reference.

### BACKGROUND

### 1. Field

The present disclosure relates to a fuel cell system, and a method for determining a non-load operation state thereof.

### 2. Description of Related Art

A fuel cell system may produce electrical energy by using a fuel cell stack. For example, when hydrogen is used as a fuel of the fuel cell stack, it may be a measure for solving an environment problem of the earth, and thus fuel cell systems have been continuously researched and developed.

The fuel cell system may include a fuel cell stack that produces electric energy, a fuel supply device that supplies a fuel (hydrogen) to the fuel cell stack, an air supply device that supplies oxygen in air, which is an oxidizer that is necessary for an electrochemical reaction, to the fuel cell stack, a thermal management system (TMS) that removes heat of reaction of the fuel cell stack to an outside, controls an operation temperature of the fuel cell stack, and performs a water managing function, and a fuel cell system controller that controls an overall operation of the fuel cell system. In the fuel cell system, the fuel cell stack produces electricity by bringing hydrogen that is a fuel and oxygen in air into a reaction with each other, and discharges heat and water as by-products. Then, to secure safety and durability of the fuel cell stack, the water produced in the fuel cell stack has to be stably discharged to an outside of the stack.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In a non-load operation state of the fuel cell stack, hydrogen may not be supplied to the fuel cell stack or a pressure of the supplied hydrogen may be low whereby the condensate produced in the fuel cell stack may not be sufficiently discharged to an outside. In this case, the condensate produced in the fuel cell stack is accumulated in the hydrogen electrode whereby the durability of the fuel cell stack is weakened and the lifespan thereof decreases.

Accordingly, there is a need to determine a non-load operation state of the fuel cell, determine whether the condensate is accumulated in the hydrogen electrode, and discharge the condensate in the hydrogen electrode.

The technical problems to be solved by the present disclosure are not limited to the aforementioned problems, and any other technical problems not mentioned herein will be clearly understood from the following description by those skilled in the art to which the present disclosure pertains.

In a general aspect of the disclosure, a fuel cell system includes a fuel cell stack, a fuel water trap configured to store condensate generated by the fuel cell stack, and a controller configured to, after a change in a water level of the fuel water trap, determine whether the fuel cell stack is in a non-load operation state based on a first parameter indicating a ratio between a power consumption of an accessory machine and the change in the water level.

The controller may be further configured to determine whether the fuel cell stack is in the non-load operation state based on a relationship between (i) a time period during which the water level of the fuel water trap is increased by a reference unit and (ii) the first parameter.

The controller may be further configured to determine that the fuel cell stack is in the non-load operation state when a change rate of the first parameter according to a consumed time period is less than a threshold value and a consumed time period corresponding to a point, at which the change rate is less than the threshold value, is a first time period or longer than the first time period.

The controller may be further configured to determine that the condensate is accumulated in a hydrogen electrode of the fuel cell stack when a difference between consumed time periods corresponding to two adjacent points having a value of the first parameter, the change rate of which corresponds to a point of less than the threshold value is a second time period or longer than the second time period.

The controller may be further configured to initiate a warning notification to a driver when determining that the condensate is accumulated.

When a load operation state of the driver is not determined, the controller may be further configured to: control a rotation per minute (rpm) of a cooling fan to a maximum rpm; and discharge the condensate outside of the hydrogen electrode by opening the hydrogen electrode when a load operation of the driver is not detected.

The controller may be further configured to determine a lifespan of the fuel cell stack based on the relationship between the consumed time period and the first parameter.

The controller may be further configured to determine the lifespan of the fuel cell stack based on a value of the first parameter, which corresponds to a point, at which the change rate is less than the threshold value.

The controller may be in communication, by wire or wirelessly, with the fuel cell stack and the fuel water trap.

The controller may be further configured to control a discharge of the condensate stored in the fuel water trap based on the determination.

The fuel cell system may further include: a hydrogen tank; a hydrogen line for supplying hydrogen from the hydrogen tank to the fuel cell stack; and a fuel cut-off valve (FCV) disposed between the hydrogen tank and a fuel supply valve (FSV) in the hydrogen supply line, the FSV disposed between the FCV and a fuel ejector (FEJ) in the hydrogen supply line, wherein the controller is further configured to: control the FCV to open in a start-on state and close in a start-off state of the fuel cell system, and adjust pressure of the hydrogen supplied to the fuel cell stack; and

control the FEJ to supply the hydrogen to the fuel cell stack by applying pressure to hydrogen passed through the FSV.

The hydrogen line may connect to an outlet of the fuel cell stack and the FEJ to form a circulation route for the hydrogen, and the hydrogen discharged by the fuel ejector FEJ may produce electric energy by reacting with air in the fuel cell stack, and the hydrogen that failed to react may be discharged through the outlet of the fuel cell stack to be reintroduced into the fuel ejector FEJ to improve a reaction efficiency of the hydrogen.

In another general aspect of the disclosure, a method for determining whether a fuel cell stack is in a non-load operation state, includes: acquiring a measure of a change in a water level of a fuel water trap configured to store condensate discharged from a fuel cell stack; calculating a first parameter indicating a ratio between a power consumption of an accessory machine and the measure of the change of the water level; and determining whether the fuel cell stack is in the non-load operation state based on the first parameter.

The method may further include: determining whether the condensate is accumulated in a hydrogen electrode of the fuel cell stack based on determining that the fuel cell stack is in the non-load operation state; and discharging the condensate to an outside of the hydrogen electrode based on determining that the condensate is accumulated in the hydrogen electrode.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a structure of a fuel cell system according to an embodiment disclosed in the present disclosure;

FIG. 2 is a block diagram of a fuel cell system according to an embodiment disclosed in the present disclosure;

FIG. 3 is a view illustrating an example of a relationship of a consumed time of a fuel cell system and a first parameter according to an embodiment disclosed in the present disclosure;

FIG. 4 is a view illustrating a method for determining a lifespan of a fuel cell system according to an embodiment disclosed in the present disclosure;

FIG. 5 is a flowchart illustrating a method for determining whether a fuel cell system is in a non-operation state according to an embodiment disclosed in the present disclosure; and

FIG. 6 is a flowchart illustrating a process of determining whether a fuel cell system is in a non-load operation state according to an embodiment disclosed in the present disclosure.

### DETAILED DESCRIPTION

Hereinafter, various embodiments of the present disclosure will be described with reference to the accompanying drawings. Accordingly, those of ordinary skill in the art will recognize that modifications, equivalents, and/or alternatives on the various embodiments described herein can be variously made without departing from the scope and spirit of the present disclosure.

In the present disclosure, it is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “1st” and “2nd” or “first” and “second” may be used to simply distinguish a corresponding component from another, and does not limit the components in other aspects (e.g., an importance or an order). When it is mentioned that a certain (e.g., a first) component is “coupled to” or “connected to” another (e.g., a second) component together with or without a term of “functionally” or “communicatively”, it means that the former component may be connected to the latter component through a third component, directly (e.g., by wire) or wirelessly.

The components (e.g., modules or programs) described in the present disclosure may include a singular entity or a plurality of entities. According to various embodiments, among the components, one or more components or operations may be omitted or one or more other components or operations may be added. Alternatively or additionally, the plurality of components (e.g., modules or programs) may be integrated into one component. In this case, the integrated components may perform one or more functions of the plurality of components in a way that is the same as or similar to that performed by the corresponding ones of the plurality of components before the integration. According to various embodiments, the operations performed by modules, programs, or other components may be executed sequentially, in parallel, repeatedly, or heuristically, one or more operations may be executed in another sequence or omitted, or one or more other operations may be added.

The term “module” or “part” used in the present disclosure may include a unit configured in a hardware, software, or firmware way, and for example, may be used interchangeably with the terms such as logic, a logic block, a component, or a circuit. The module may be an integral part, or a minimum unit or a portion which performs one or more functions. For example, according to an embodiment, the module may be implemented in a form of an application-specific integrated circuit (ASIC).

Various embodiments of the present disclosure may be implemented by software (e.g., a program or an application) including one or more instructions stored in a storage medium (e.g., a memory) that may be read by a machine. For example, a processor of a device may call, among one or more instructions stored in a storage medium, at least one instruction, and may execute the instruction. This allows at least one function to be performed according to the called at least one instruction. The one or more instructions may include a code that is made by a compiler or a code that may be executed by an interpreter. The storage medium that may be read by a device may be provided in a form of a non-transitory storage medium. Here, the ‘non-transitory storage medium’ means that the storage medium is a tangible device and does not include a signal (e.g., an electromagnetic wave), and with regard to the term, a case, in which data are semi-permanently stored in the storage medium, and a case, in which data are temporarily stored in the storage medium, are not distinguished.

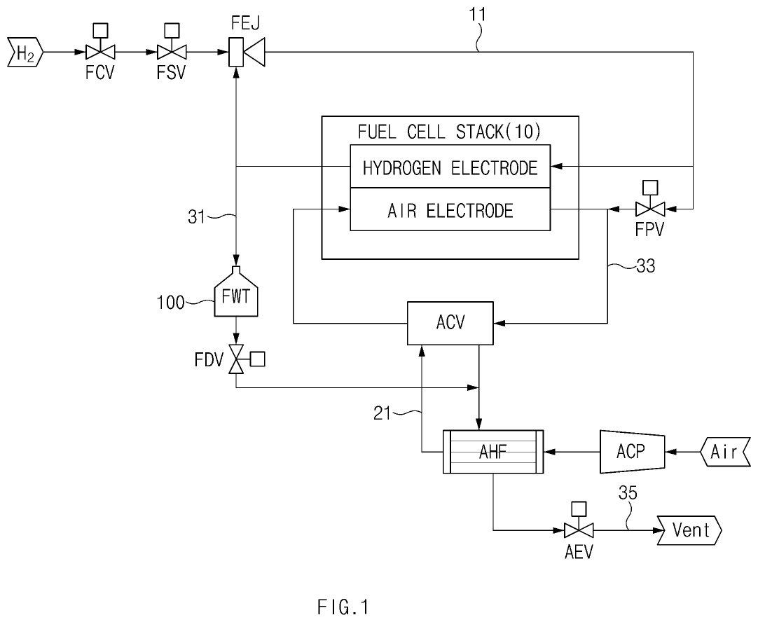

FIG. 1 is a view illustrating a structure of a fuel cell system according to an embodiment disclosed in the present disclosure.

Referring to FIG. 1, a fuel cell system may include a fuel cell stack 10, and may further include a hydrogen supply line 11 that is connected to a hydrogen electrode of the fuel cell stack 10 such that hydrogen supplied to the fuel cell stack 10 flows therethrough, an air supply line 21 that is connected to an air electrode of the fuel cell stack 10 such that air supplied to the fuel cell stack 10 flows there though, and discharge lines 31, 33, and 35 for discharging moisture (water) and non-reaction gases that are reaction by-products, and a purge line.

The fuel cell stack 10 (or may referenced as a ‘fuel cell’) may have a structure that may produce electricity through an oxidation/reduction reaction of a fuel (for example, hydrogen) and an oxidizer (for example, air).

As an example, the fuel cell stack 10 may include a membrane electrode assembly (MEA), in which catalyst electrode layers, in which an electrochemical reaction occurs, are attached on opposite sides of an electrolyte membrane, through which hydrogen ions travel, a gas diffusion layer (GDL) that functions to uniformly distribute reaction gases and deliver generated electrical energy, a gasket and a coupling tool for maintaining a sealing performance and a proper coupling pressure for the reaction gases and a cooling water, and a bipolar plate, through which the reaction gases and cooling fluid flow.

In the fuel cell stack 10, hydrogen that is a fuel and air (oxygen) that is an oxidizer may be supplied to an anode and a cathode of the membrane electrode assembly through passages of the bipolar plate, and for example, hydrogen may be supplied to the anode that is a hydrogen electrode and the air may be supplied to a cathode that is an air electrode.

The hydrogen supplied to the anode is decomposed to protons and electrons by catalysts of the electrode layers on opposite sides of an electrolyte membrane, and among them, only the hydrogen ions may be delivered to the cathode after selectively passing through the electrolyte membrane that is a positive ion exchange membrane, and the electrons may be delivered to the cathode through the gas diffusion layer and the bipolar plate that are conductors. In the cathode, the hydrogen ions supplied through the electrolyte membrane and the electrons delivered through the bipolar plate may generate a reaction of producing water while meeting oxygen in the air supplied to the cathode by an air supply apparatus. Due to flows of the hydrogen ions, which occur then, the electrons flow through an external wire, and currents may be generated due to the flows of the electrons.

A fuel cut-off valve FCV, a fuel supply valve FSV, a fuel ejector FEJ, and the like may be disposed in the hydrogen supply line 11. Furthermore, for example, the hydrogen supply line 11 may be connected to a hydrogen tank.

The fuel cut-off valve FCV may be disposed between the hydrogen tank and the fuel supply valve FSV in the hydrogen supply line 11, and may function to cut off supply of hydrogen discharged from the hydrogen tank to the fuel cell stack 10. The fuel cut-off valve FCV may be controlled to be opened in a start-on state of the fuel cell system and to be closed in a start-off state thereof.

The fuel supply valve FSV may be disposed between the fuel cut-off valve FCV and the fuel ejector FEJ in the hydrogen supply line 11, and may function to adjust a pressure of the hydrogen supplied to the fuel cell stack 10. As an example, the fuel supply valve FSV may be controlled to be opened to supply hydrogen when a pressure of the hydrogen supply line 11 decreases and to be closed when the pressure of the hydrogen supply line 11 increases.

The fuel ejector FEJ may be disposed between the fuel supply valve FSV and the fuel cell stack 10 in the hydrogen supply line 11, and may function to supply the hydrogen to the fuel cell stack 10 by applying a pressure to the hydrogen that passed through the fuel supply valve FSV.

The hydrogen supply line 11 may connect an outlet of the fuel cell stack 10 and the fuel ejector FEJ to form a circulation route of hydrogen. Accordingly, the hydrogen discharged by the fuel ejector FEJ may produce electric energy by reflecting air in the fuel cell stack 10, and the hydrogen that failed to react may be discharged through the outlet of the fuel cell stack 10 to be reintroduced into the fuel ejector FEJ. In this case, the hydrogen that failed to react may be reintroduced into the fuel ejector FEJ to be supplied to the fuel cell stack 10 again whereby a reaction efficiency of the hydrogen may be enhanced.

Moisture that is present in the hydrogen supply line 11 may be condensed in a process of recirculation of the hydrogen that failed to react in the hydrogen electrode of the fuel cell stack 10. Then, the condensate may be discharged through the first discharge line 31 that connects one point on the hydrogen supply line 11, in which the hydrogen that failed to react in the hydrogen electrode of the fuel cell stack 10 flows to the fuel ejector FEJ and an air humidifier AHF.

A fuel water trap FWT 100 and a fuel drain valve FDV may be disposed on the first discharge line 31.

The fuel water trap FWT 100 may function to store the condensate introduced from one point of the hydrogen supply line 11 to the first discharge line 31.

The fuel drain valve FDV may function to discharge the condensate stored in the fuel water trap FWT to the air humidifier AHF along the first discharge line 31. Here, the fuel drain valve FDV may be controlled to be in a closed state before a water level of the condensate stored in the fuel water trap 100 exceeds a specific water level and to be opened when the water level of the condensate stored in the fuel water trap FWT exceeds the specific water level such that the condensate is discharged along the first discharge line 31.

An air compressor ACP, the air humidifier AHF, an air cut-off valve ACV, and the like may be disposed in the air supply line 21.

The air compressor ACP may be disposed on the air supply line 21 between an air suction hole, through which ambient air is suctioned, and the air humidifier AHF, and may function to suction and compress the ambient air and supply the compressed air.

The air humidifier AHF may be disposed between the air compressor and the air cut-off valve ACV in the air supply line 21, and may function to adjust a humidity of the air suctioned and compressed by the air compressor ACP and supply the air to the air electrode of the fuel cell stack 10. When the air compressed by the air compressor ACP is introduced through an inlet of the air humidifier, the air humidifier AHF may adjust the humidity by supplying moisture to the introduced air. As an example, the air humidifier AHF may humidify the air supplied from the air compressor ACP by using the condensate introduced through the first discharge line 31 or the moisture included in an air discharged through the second discharge line 33 that connects the air electrode of the fuel cell stack 10 and the air humidifier AHF.

The air humidifier AHF may be connected to the first discharge line 31. Accordingly, the air humidifier AHF may supply moisture to the air supplied from the air compressor ACP by using the condensate introduced through the first discharge line 31.

Furthermore, the air humidifier AHF may be connected to an air discharge hole of the fuel cell stack 10 through the second discharge line 33, and the air discharged from the air electrode of the fuel cell stack 10 may be introduced into the air humidifier AHF through the second discharge line 33. Here, because the air discharged from the air electrode of the fuel cell stack 10 contains moisture, the air humidifier AHF may perform humidification through exchange of moisture between the air discharged from the air electrode of the fuel cell stack 10 and the air supplied from the air compressor ACP. In this way, the air, to which the moisture has been supplied by the air humidifier AHF, may be introduced into the air electrode of the fuel cell stack 10 and may produce water as a reactant after reacting with the hydrogen.

Meanwhile, the air humidifier AHF may be connected to an external discharge hole through the third discharge line 35, and may discharge the air introduced through the second discharge line 33 to an outside through the third discharge line 35. Then, an air exhaust valve AEV may be disposed in the third discharge line 35.

The air cut-off valve ACV may be disposed on the air supply line 21 that connects the fuel cell stack 10 and the air humidifier AHF, and may cut off supply the hydrogen discharged from the air humidifier AHF to the air electrode of the fuel cell stack 10 or may adjust a pressure of the air supplied to the air electrode of the fuel cell stack 10. As an example, the air cut-off valve ACV may be controlled to be opened in a start-on state of the fuel cell system and be closed in a start-off state.

Furthermore, the air cut-off valve ACV may be connected to the second discharge line 33 that connects the fuel cell stack 10 and the air humidifier AHF. The air cut-off valve ACV may cut off supply the air discharged from the air electrode of the fuel cell stack 10 to the air humidifier AHF or may adjust a pressure of the air supplied from the air electrode of the fuel cell stack 10 to the air humidifier AHF.

FIG. 1 illustrates that the air cut-off valve ACV is integrated with and disposed in the air supply line 21 and the second discharge line 33, a first air cut-off valve (not illustrated) disposed on the air supply line 21 and a second air cut-off valve (not illustrated) disposed on the second discharge line 33 may be implemented in a separated form.

Meanwhile, a purge line may be connected to one point on the hydrogen supply line 11, in which the hydrogen supplied from the fuel ejector FEJ flows to the hydrogen electrode of the fuel cell stack 10, and a fuel-line purge valve FPV may be disposed on the purge line.

The fuel-line purge valve FPV is a valve that is opened and closed to manage concentrations of hydrogen in the fuel cell stack 10 and the hydrogen supply line 11, and may function to maintain the concentration of the hydrogen in the fuel cell stack 10 and the hydrogen supply line 11 in specific ranges.

The fuel cell stack 10 may produce electric energy by using hydrogen and air, and the fuel-line purge valve FPV is in a closed state while the fuel cell stack 10 is operated in a normal state.

Here, the air supplied to the fuel cell stack 10 contains nitrogen in addition to oxygen, and voltages of cells may decrease as crossover occurs due to a difference of partial pressures of the nitrogen in the hydrogen electrode and the air electrode. Accordingly, the fuel-line purge valve FPV may discharge residual hydrogen to increase a concentration of the hydrogen in the hydrogen electrode whereby a performance of the stack may be maintained by decreasing a concentration of the nitrogen. The fuel-line purge valve FPV may be opened to purge the hydrogen when an accumulated current that is calculated by integrating currents generated in the fuel cell stack 10 for a specific time period exceeds a target value whereby the concentration of the hydrogen in the hydrogen electrode may be controlled to be maintained at a specific value or more.

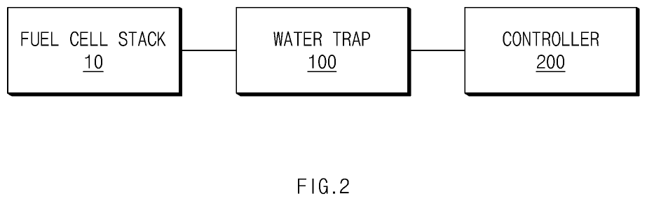

FIG. 2 is a block diagram of the fuel cell system according to an embodiment disclosed in the present disclosure.

Referring to FIG. 2, the fuel cell system may include the fuel cell stack 10, the fuel water trap 100, and a controller 200 (e.g., one or more processors).

According to an embodiment, the fuel water trap 100 may store the condensate generated by the fuel cell stack 10. The condensate generated in the fuel cell stack 10 through a chemical reaction may be introduced into the fuel water trap 100 along the first discharge line 31 and may be stored in the fuel water trap 100. The fuel water trap 100 may include a water level sensor (not illustrated) for measuring a water level of the condensate.

According to an embodiment, the controller 200 may be a hardware device, such as a processor, a micro-processor unit (MPU), a micro controller unit (MCU), a central processing unit (CPU), or an electronic controller unit (ECU), or a program that is implemented by a processor. The controller 200 may be connected to various configurations of the fuel cell system to perform an overall function for control of a thermal management system. As an example, the controller 200 may be a fuel cell control unit (FCU) that controls overall functions of the fuel cell system.

According to an embodiment, the controller 200 may communicate with the components that constitute the fuel cell system, for example, the fuel cell stack 10, the water level sensor, and a cooling fan by wire or wirelessly, and as an example, may perform communication based on CAN communication.

According to an embodiment, the controller 200 may determine whether the fuel cell stack is in a non-load operation state when the water level of the fuel water trap 100 is changed. The controller 200 may receive information of the water level of the fuel water trap 100 from the water level sensor of the fuel water trap 100 and may acquire a change in the water level. Here, the non-load operation of the fuel cell stack may mean a state, in which there is no electric power required by the loads driven by the motor, except for accessory machines, for example, in vehicles or flying objects, on which the fuel cell stack is mounted. Then, the controller 200 may further identify whether a target pressure of the hydrogen electrode of the fuel cell stack 10 and an actual pressure of the hydrogen electrode are the same preset value. The preset value, for example, may be 1 bar.

Even when the fuel cell stack 10 is in the non-load operation state, electric power may be consumed in the accessory machines and the like, and thus the electric power of the fuel cell stack 10 is not zero. For example, the fuel cell stack 10 may produce minimum electric power for controlling the accessory machines and the like by operating the air compressor ACP at a minimum rpm and controlling an opening degree of the fuel supply valve FSV to a minimum opening degree. Accordingly, the condensate may be produced in the fuel cell stack 10 even in the non-load operation state of the fuel cell stack 10. Accordingly, the fuel cell system may determine whether the fuel cell stack is in the non-load operation state and determine whether the condensate is accumulated in the hydrogen electrode whereby the condensate accumulated in the hydrogen electrode may be smoothly discharged even in the non-load operation state.

According to an embodiment, the controller 200 may determine whether the fuel cell stack 10 is in the non-load operation state based on a first parameter indicating a ratio of a power consumption of the accessory machines and a change in the water level of the fuel water trap 100. For example, the first parameter may be defined as (the power consumption of the accessory machines)/(the change in the water level of the fuel water trap). Here, the accessory machines may include various devices that constitute an air conditioning system and the like.

The power consumption of the accessory machines may be calculated from the electric power of the fuel cell stack and the electric power of a high-voltage battery. For example, the power consumption of the accessory machines may be calculated by subtracting the electric power charged by the high-voltage battery from the electric power generated by the fuel cell stack 10. As an example, the power consumption of the accessory machines may be calculated as in ∫(stack voltage×stack current)−(voltage of high−voltage battery×current of high−voltage battery)dt.

Here, the high-voltage battery may be provided in the fuel cell system and may be charged by the electric power produced by the fuel cell stack 10, may supply electric power to loads, and may be operated mutually complementarily with the fuel cell stack 10.

According to an embodiment, the controller 200 may determine whether the fuel cell stack 10 is in the non-load operation state, based on a relationship between a time period that is consumed to increase the water level of the fuel water trap 100 by a reference unit, and the first parameter. The reference unit may be determined in advance, and for example, may be 1 mm. The electric power required by the fuel cell stack 10 will increase as the power consumption of the load increases in the fuel cell system, and thus, an amount of the condensate produced through a chemical reaction in the fuel cell stack 10 will increase. That is, as the power consumption of the load increases, the time period that is consumed to increase the water level of the fuel water trap 100 may decrease, and the value of the first parameter may increase. Accordingly, the controller 200 may determine whether the fuel cell stack 10 is in the non-load operation state, based on the change in the water level of the fuel water trap 100 and the value of the first parameter.

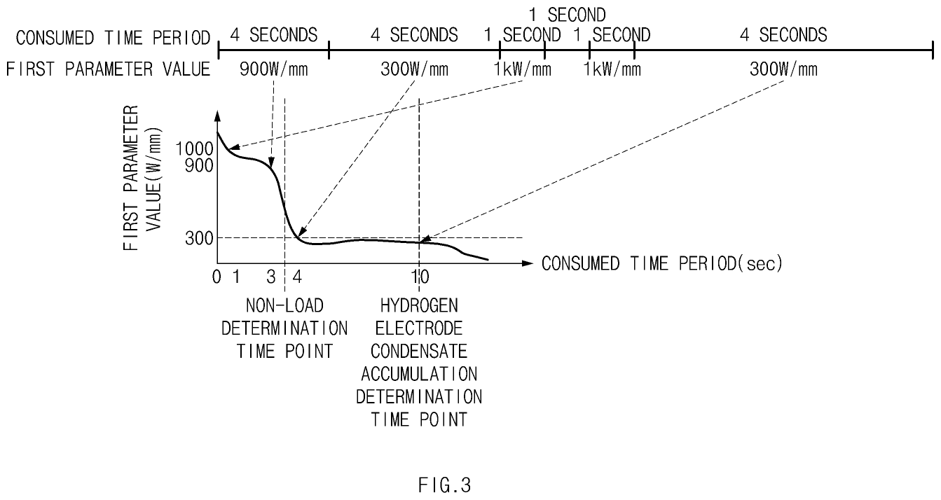

For example, the controller 200 may store a relationship between the consumed time period and the first parameter as a graph as illustrated in FIG. 3. As an example, when the value of the first parameter is 300 W/mm when 4 seconds are consumed to increase the water level of the fuel water trap 100 by 1 mm at a specific time point during the operation of the fuel cell system, the controller 200 may show point (4, 300) on the graph. In this case, the value of the first parameter may be a sum of the electric power consumed by the accessory machines for 4 seconds. The controller 200 may show the consumed time periods acquired during the operation of the fuel cell system and the values of the first parameter for the consumed time period as points on the graph, and may identify a relationship between the consumed time period and the first parameter by applying an interpolation to the acquired points.

According to an embodiment, the controller 200 may determine that the fuel cell stack 10 is in the non-load operation state when a change rate of the first parameter according to the consumed time period is less than a threshold value and a consumed time period corresponding to a point, at which the change rate is less than the threshold value, is a first time period or more. Then, the change rate of the first parameter may mean a change amount (that is, a change amount in they axis) of the value of the first parameter when the consumed time is increased by one second on the above-described graph, that is, an inclination thereof. For example, the controller 200 may calculate a change rate of the first parameter as −600 W/mm/s at the corresponding point (a point when the consumed time period is 4 seconds) when the value of the first parameter is 900 W/mm when the data acquired during an operation of the fuel cell stack 10 is a consumed time of 3 seconds and when the value of the first parameter is 300 W/mm when the consumed time period is 4 seconds. In this case, the controller 200 may determine that the electric power of the load decreases. Then, the point, at which the change rate is less than the threshold value may mean a point (that is, 4 seconds in the above example) after the change. Furthermore, the controller 200 may determine that the fuel cell stack 10 is in the non-load operation state by determining that the state, in which the load decreases, continues for a specific time period when a consumed time period corresponding to a point, at which the change rate is less than the threshold value, is the first time period or more. Here, the threshold value of the change rate and the first time period may be changed according to a performance of the fuel cell stack 10, and may be determined through experiments and the like.

According to an embodiment, the controller 200 may determine that the condensate is accumulated in the hydrogen electrode of the fuel cell stack 10 when a difference between consumed time periods corresponding to two adjacent points having a value of the first parameter corresponding to point, at which the change rate of the first parameter is less than the threshold value. The second time period may be determined in advance, and may be differently determined according to an amount of the condensate accumulated in the hydrogen electrode during the non-load operation. The controller 200 may determine that the condensate is accumulated in the hydrogen electrode by determining that the non-load operation state sufficiently continues when the difference between the consumed time periods corresponding the two points is a second time period or more.

According to an embodiment, the controller 200 may give a warning notification to the driver when determining that the condensate is accumulated in the hydrogen electrode. For example, the controller 200 may display a notification message that guides a load operation to a front display and the like of the vehicle or notifies ending of an operation, and in another example, may output a voice message through an acoustic device, such as a speaker.

In another embodiment, the controller 200 may perform a control such that the condensate is discharged from the hydrogen electrode by compulsorily increasing an output of the load when determining that the condensate is accumulated in the hydrogen electrode. That is, the controller 200 may allow the condensate in the hydrogen electrode to be discharged, by compulsorily increasing the output of the load when the driver does not take any action, such as an operation of the load or ending the operation even when the notification is given to the driver. Then, the load, the output of which is increased by the controller 200 may be selected as a load, such as a cooling fan, which does not greatly influence the operation of the fuel cell stack 10.

The condensate may be controlled to be discharged from the hydrogen electrode by controlling the fuel cell stack 10 and the cooling fan. That is, the controller 200 may allow the condensate in the hydrogen electrode to be discharged, by compulsorily increasing the output of the load when the driver does not take an action, such as an operation of the load by the driver or ending of the operation even when a notification is given to the driver.

According to an embodiment, the controller 200 may perform a control such that the condensate is discharged from the hydrogen electrode by controlling an rpm of the cooling fan to a maximum rpm and opening the hydrogen electrode when not detecting an operation of the load by the driver. A case, in which the operation of the load by the driver is not detected, may include a case, in which the required output of the load is 0. For example, when the output of the load is not increased, for example, when an operation of the load, such pushing a pedal or manipulating a steering wheel, is not performed even through the controller 200 sends an alarm, the controller 200 may generate an output by compulsorily driving the cooling fan. In this way, the controller 200 may allow the condensate to be discharged to an outside of the hydrogen electrode by performing a control such that the high-voltage is exhausted by controlling the rpm of the cooling fan to a maximum rpm and the pressure of the hydrogen becomes higher in the fuel cell stack 10 by opening the hydrogen electrode. Accordingly, the controller 200 may charge the electric power produced by the fuel cell stack 10 in the high-voltage battery while discharging the condensate from the hydrogen electrode.

In this way, the fuel cell system may determine whether the fuel cell system is in the non-load operation and the condensate is accumulated in the hydrogen electrode even when an operation of the load by the driver is not performed, and may discharge the condensate in the hydrogen electrode to an outside of the hydrogen electrode by compulsorily increasing a thrust of the load. Accordingly, the fuel cell system may enhance a durability and a lifespan of the fuel cell stack 10.

According to an embodiment, the controller 200 may determine a lifespan of the fuel cell stack 10 based on a relationship between the consumed time period and the first parameter.

In an embodiment, the controller 200 may determine a lifespan of the fuel cell stack 10 based on a value of the first parameter corresponding to a point, at the change rate of the first parameter is less than the threshold value. The value of the first parameter corresponding to the point, at which the change rate of the first parameter is less than the threshold value, may increase as the number of uses of the fuel cell stack 10 increases. Accordingly, the controller 200, for example, may estimate the number of uses of the fuel cell stack 10 such that the change rate of the first parameter is proportional to the value of the first parameter corresponding to the point, at which it is less than the threshold value, and may estimate a lifespan of the fuel cell stack 10 from the number of uses.

In another embodiment, the controller 200 may determine a lifespan of the fuel cell stack 10 based on a difference between the consumed time periods corresponding adjacent two points having a first parameter value corresponding to a point, at which the change rate of the parameter is less than the threshold value. As the number of uses of the fuel cell stack 10 increases, reverse osmosis of the hydrogen electrode decreases whereby the difference between the consumed time periods corresponding to the adjacent two points having the first parameter value corresponding to the point, at which the change rate of the first parameter is less than the threshold value. Accordingly, the controller 200 may estimate the number of uses of the fuel cell stack 10 such that the number of uses is proportional to the difference between the consumed time periods of the two points, and may estimate a lifespan of the fuel cell stack 10 from the number of uses.

In another embodiment, the controller 200 may determine the lifespan of the fuel cell stack 10 based on a bandwidth of the graph acquired by applying an interpolation to the consumed times and the first parameters. The controller 200 acquires the graph by applying an interpolation to a finite number of points for the consumed time periods and the first parameters acquired during an operation of the fuel cell system, and thus the estimation graph, to which the interpolation is applied, has a bandwidth. Then, as the number of uses of the fuel cell increases, a bandwidth of the estimation graph tends to be wider. Accordingly, the controller 200, for example, may estimate the number of uses of the fuel cell stack 10 such that the number of uses is proportional to the bandwidth of the estimation graph, and may estimate a lifespan of the fuel cell stack 10 from the number of uses.

In this way, the fuel cell system may calculate the residual lifespan of the fuel cell stack 10, and thus, may efficiently manage the lifespan of the fuel cell stack 10.

FIG. 3 is a view illustrating an example of a relationship of the consumed time period of the fuel cell system and the first parameter according to an embodiment disclosed in the present disclosure.

Referring to FIG. 3, the controller 200 may acquire a graph depicting a relationship from the consumed time period acquired during an operation of the fuel cell stack 10 and the value of the first parameter.

Then, it should be noted that the x axis on the graph indicates not lapse of time but the consumed time period, and thus, it should be noted that the graph is acquired according not to a sequence of the operation times but a sequence of the consumed time periods. In FIG. 3, the controller 200 may determine a point, at which a consumed time period, for which a change rate of the first parameter is less than a threshold value, is 4 seconds, as a non-load operation time point, and may determine a point, at which a consumed time period having the same value of 300 W/mm that is a first parameter value at a point, at which the consumed time period is 4 seconds, as a hydrogen electrode condensate accumulation time point.

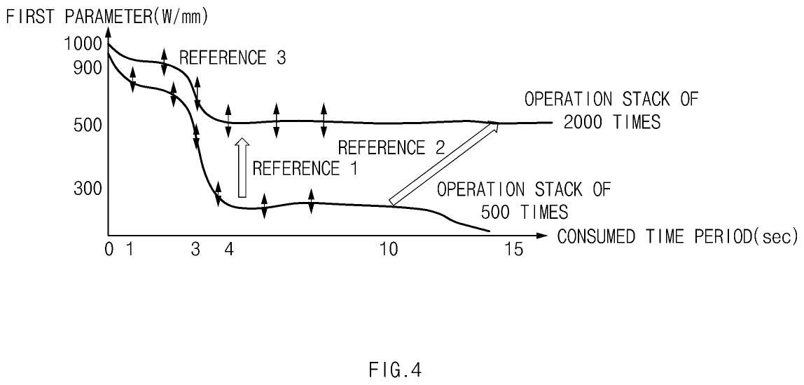

FIG. 4 is a view illustrating a method for determining a lifespan of the fuel cell system according to an embodiment disclosed in the present disclosure.

Referring to FIG. 4, it may be identified that a relationship between the consumed time period and the first parameter is changed according to the number of operations of the fuel cell stack. That is, it may be identified that, as the number of operations of the fuel cell stack increases, a value of the first parameter corresponding to a point, at which a change rate of the first parameter is less than a threshold value, a difference between consumed time periods corresponding to adjacent two point having the value of the first parameter corresponding to the point, at which the change rate of the first parameter is less than the threshold value, and a bandwidth of the graph is widened.

Accordingly, the controller 200 may estimate a lifespan of the fuel cell stack 10 from data acquired during an actual operation of the fuel cell system by using the properties. In FIG. 4, reference 1 may mean a value of a first parameter corresponding to a point, at which a change rate of the first parameter is less than a threshold value, reference 2 may mean a difference between consumed time periods of adjacent two points having the first parameter corresponding to the point, at which the change rate of the first parameter is less than the threshold value, reference 3 may mean a bandwidth of the graph, and the controller 200 may determine a lifespan of the fuel cell stack 10 based on at least one of references 1 to 3.

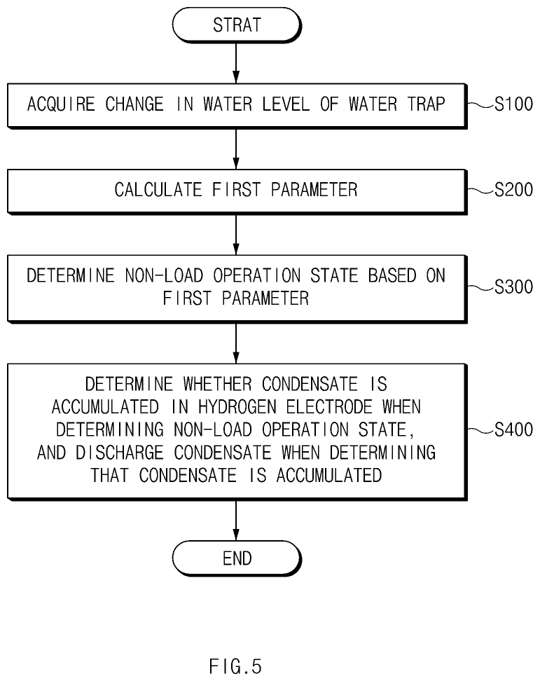

FIG. 5 is a flowchart illustrating a method for determining whether the fuel cell system is in a non-operation state according to an embodiment disclosed in the present disclosure. FIG. 5 may be described by using the components of FIGS. 1 and 2.

The embodiment illustrated in FIG. 5 is a simple embodiment, and a sequence of the operations according to various embodiments of the present disclosure may be different from the illustration of FIG. 5, and some operations illustrated in FIG. 5 may be omitted, a sequence of the operation may be changed, or the operations may be combined.

Referring to FIG. 5, the method for determining whether the fuel cell system is in a non-load operation state, includes an operation of acquiring a change in a water level of the fuel water trap (S100), an operation of calculating a first parameter (S200), an operation of determining whether the fuel cell stack is in a non-load operation state based on the first parameter (S300), and an operation of determining that condensate in the hydrogen electrode is accumulated when determining that the fuel cell system is in a non-load operation state, and discharging the condensate when determining that the condensate is accumulated (S400).

In operation S100, the controller 200 may acquire a change in a water level of the fuel water trap 100. The fuel water trap 100 may include a water level sensor, and the controller 200 may receive water level information from the water level sensor to acquire a change in the water level.

In operation S200, the controller 200 may calculate the first parameter. The first parameter may indicate a ratio of a power consumption of an accessory machine and the change in the water level. For example, the first parameter may be defined as (the consumed power of the accessory machine)/(the change in the water level). The controller 200 may calculate the power consumption of the accessory machine by subtracting electric power of the high-voltage battery from electric power of the fuel cell stack 10.

In operation S300, the controller 200 may determine whether the fuel cell stack 10 is in a non-load operation state, based on the first parameter. For example, the controller 200 may determine whether the fuel cell stack 10 is in a non-load operation state, based on a relationship between the time period consumed to increase the water level of the fuel water trap by a reference unit, and the first parameter.

In operation S400, the controller 200 may determine whether the condensate is accumulated in the hydrogen electrode when determining that the fuel cell stack 10 is in the non-load operation state. The controller 200 may give a warning notification to the driver when determining that the fuel cell stack 10 is in the non-load operation state.

The controller 200 may allow the condensate to be discharged to an outside of the hydrogen electrode when determining that the condensate is accumulated. For example, the controller 200 may perform a control such that the condensate is discharged to an outside of the hydrogen electrode by controlling an rpm of the cooling fan to a maximum rpm and opening the hydrogen electrode.

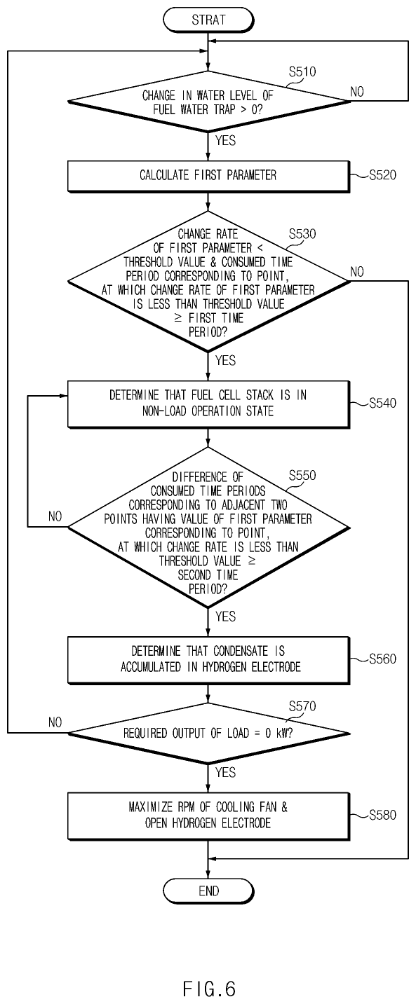

FIG. 6 is a flowchart illustrating a process of determining whether the fuel cell system is in a non-load operation state according to an embodiment disclosed in the present disclosure.

In operation S510, the controller 200 may determine whether a change in the water level of the fuel water trap 100 is more than 0. The controller 200 may proceed to operation S520 when the change in the water level of the fuel water trap 100 is more than 0 (S510—Yes). The controller 200 may return to a start operation when the water level of the fuel water trap 100 is 0 or less (S510—No).

In operation S520, the controller 200 may calculate the first parameter. The first parameter may indicate a ratio of the power consumption of the accessory machine and the change in the water level.

In operation S530, the controller 200 may determine whether the change rate of the first parameter is less than the threshold value and a consumed time period corresponding to a point, at which the change rate of the first parameter is less than a threshold value, is a first time period or more. The controller 200 may proceed to S540 when the change rate of the first parameter is less than the threshold value and a consumed time period corresponding to a point, at which the change rate of the first parameter is less than the threshold value, is the first time period or more (S530—Yes). The controller 200 may end the procedure when the change rate of the first parameter is the threshold value or more and a consumed time period corresponding to a point, at which the change rate of the first parameter is less than the threshold value, is less than the first time period (S530—No).

In operation S540, the controller 200 may determine that the fuel cell stack 10 is in the non-load operation state.

In operation S550, the controller 200 may determine whether a difference of two consumed time periods corresponding to adjacent two points having the value of the first parameter corresponding to a point, at which the change rate is less than the threshold value, is a second time period or more. The controller 200 may proceed to operation S560 when the difference of the consumed time periods is the second time period or more (S550—Yes). The controller 200 may return to operation S540 when the difference of the consumed time periods is less than the second time period.

In operation S560, the controller 200 may determine that the condensate is accumulated in the hydrogen electrode. Then, the controller 200 may give a warning notification to the driver.

In operation S570, the controller 200 may determine whether a required output of the load is 0. That is, the controller 200 may determine whether an operation of the load by the driver is performed. The controller 200 may proceed to operation S580 when the required output of the load is 0 (S570—Yes). The controller 200 may return to a start operation when the required output of the load is not 0.

In operation S580, the controller 200 may control an rpm of the cooling fan to a maximum value and control the hydrogen electrode of the fuel cell stack 10 to be opened. Through this, the controller 200 may allow the condensate in the hydrogen electrode to be discharged to an outside of the hydrogen electrode.

The fuel cell system according to the embodiment disclosed in the present disclosure may enhance the durability and lifespan of the fuel cell stack by determining whether the condensate is accumulated in the hydrogen electrode during a non-load operation thereof and allowing the condensate to be discharged.

Furthermore, the fuel cell system according to the embodiments disclosed in the present disclosure may calculate a residual lifespan of the fuel cell stack, and thus, may efficiently manage a lifespan of the fuel cell stack.

In addition, various effects directly or indirectly recognized through the present disclosure may be provided.

Although it may have been described until now that all the components constituting the embodiments of the present disclosure are coupled to one or coupled to be operated, the present disclosure is not essentially limited to the embodiments. That is, without departing from the purpose of the present disclosure, all the components may be selectively coupled into one or more components to be operated.

Furthermore, because the terms, such as “comprising”, “including”, or “having” may mean that the corresponding component may be included unless there is a specially contradictory description, it should be construed that another component is not excluded but may be further included. In addition, unless defined otherwise, all terms used herein, including technical or scientific terms, have the same meanings as those generally understood by those skilled in the art to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

The above description is a simple exemplification of the technical spirits of the present disclosure, and the present disclosure may be variously corrected and modified by those skilled in the art to which the present disclosure pertains without departing from the essential features of the present disclosure. Accordingly, the embodiments disclosed in the present disclosure is not provided to limit the technical spirits of the embodiments of the present disclosure but provided to describe the present disclosure, and the scope of the technical spirits of the present disclosure is not limited by the embodiments. Accordingly, the genuine technical scope of the present disclosure should be construed by the attached claims, and all the technical spirits within the equivalent ranges fall within the scope of the present disclosure.

What is claimed is:

1. A fuel cell system comprising:
a fuel cell stack;
a fuel water trap configured to store condensate generated by the fuel cell stack; and
a controller configured to, after a change in a water level of the fuel water trap, determine whether the fuel cell stack is in a non-load operation state based on a first parameter indicating a ratio between a power consumption of an accessory machine and the change in the water level.

2. The fuel cell system of claim 1, wherein the controller is further configured to determine whether the fuel cell stack is in the non-load operation state based on a relationship between (i) a time period during which the water level of the fuel water trap is increased by a reference unit and (ii) the first parameter.

3. The fuel cell system of claim 2, wherein the controller is further configured to determine that the fuel cell stack is in the non-load operation state when a change rate of the first parameter according to a consumed time period is less than a threshold value and a consumed time period corresponding to a point, at which the change rate is less than the threshold value, is a first time period or longer than the first time period.

4. The fuel cell system of claim 3, wherein the controller is further configured to determine that the condensate is accumulated in a hydrogen electrode of the fuel cell stack when a difference between consumed time periods corresponding to two adjacent points having a value of the first parameter, the change rate of which corresponds to a point of less than the threshold value is a second time period or longer than the second time period.

5. The fuel cell system of claim 4, wherein the controller is further configured to initiate a warning notification to a driver when determining that the condensate is accumulated.

6. The fuel cell system of claim 5, wherein, when a load operation state of the driver is not determined, the controller is further configured to:
control a rotation per minute (rpm) of a cooling fan to a maximum rpm; and
discharge the condensate outside of the hydrogen electrode by opening the hydrogen electrode when a load operation of the driver is not detected.

7. The fuel cell system of claim 3, wherein the controller is further configured to determine a lifespan of the fuel cell stack based on the relationship between the consumed time period and the first parameter.

8. The fuel cell system of claim 7, wherein the controller is further configured to determine the lifespan of the fuel cell stack based on a value of the first parameter, which corresponds to a point, at which the change rate is less than the threshold value.

9. A method for determining whether a fuel cell stack is in a non-load operation state, the method comprising:
acquiring a measure of a change in a water level of a fuel water trap configured to store condensate discharged from a fuel cell stack;
calculating a first parameter indicating a ratio between a power consumption of an accessory machine and the measure of the change of the water level; and
determining whether the fuel cell stack is in the non-load operation state based on the first parameter.

10. The method of claim 9, further comprising:
determining whether the condensate is accumulated in a hydrogen electrode of the fuel cell stack based on determining that the fuel cell stack is in the non-load operation state; and
discharging the condensate to an outside of the hydrogen electrode based on determining that the condensate is accumulated in the hydrogen electrode.

11. The fuel cell system of claim 1, wherein the controller is in communication, by wire or wirelessly, with the fuel cell stack and the fuel water trap.

12. The fuel cell system of claim 1, wherein the controller is further configured to:
control a discharge of the condensate stored in the fuel water trap based on the determination.

13. The fuel cell system of claim 1, further comprising:
a hydrogen tank;
a hydrogen line for supplying hydrogen from the hydrogen tank to the fuel cell stack; and
a fuel cut-off valve (FCV) disposed between the hydrogen tank and a fuel supply valve (FSV) in the hydrogen supply line, the FSV disposed between the FCV and a fuel ejector (FEJ) in the hydrogen supply line,
wherein the controller is further configured to:
control the FCV to open in a start-on state and close in a start-off state of the fuel cell system, and adjust pressure of the hydrogen supplied to the fuel cell stack; and
control the FEJ to supply the hydrogen to the fuel cell stack by applying pressure to hydrogen passed through the FSV.

14. The fuel cell system of claim 13,
wherein the hydrogen line connects to an outlet of the fuel cell stack and the FEJ to form a circulation route for the hydrogen, and
wherein the hydrogen discharged by the fuel ejector FEJ produces electric energy by reacting with air in the fuel cell stack, and the hydrogen that failed to react is discharged through the outlet of the fuel cell stack to be reintroduced into the fuel ejector FEJ to improve a reaction efficiency of the hydrogen.
